(19) United States
(12) Patent Application Publication
(10) Pub. No.: US 2003/0076992 A1
(43) Pub. Date: Apr. 24, 2003

(54) Neural network based element, image pre-processor, and method of pre-processing using a neural network

(76) Inventors: Michele R. Banish, Huntsville, AL (US); Heggere Ranganath, Huntsville, AL (US)

Correspondence Address: BIRCH STEWART KOLASCH & BIRCH, PO BOX 747, FALLS CHURCH, VA, 22040-0747, US

(21) Appl. No.: 10/179,970

(22) Filed: Jun. 26, 2002

Related U.S. Application Data
(60) Provisional application No. 60/300,464, filed on Jun. 26, 2001.

(51) Int. Cl. G06K 9/62; G06E 1/00

(52) U.S. Cl. 382/156; 706/15

(57) ABSTRACT

A neural network has been optimized to function as an image preprocessor. The image processor evaluates input imagery and outputs regions of interest, ignoring backgrounds or data features that differ from programmed geometries. The smart imager algorithm has been applied to medical and military datasets. Results from over 200 patient images demonstrate that the image preprocessor can reliably isolate information of diagnostic interest in pulmonary data. Similarly, a smart preprocessor reliably locates peaks in correlation surfaces in an automated target recognition application. In both cases, the smart imager is able to ignore noisy artifacts and background information, highlight features of interest and improve detection system performance.

### CROSS-REFERENCE TO RELATED APPLICATIONS

This application claims priority under 35 U.S.C. § 119(e) of provisional application U.S. Ser. No. 60/300,464 filed Jun. 26, 2001, which is hereby incorporated by reference in its entirety.

### BACKGROUND OF THE INVENTION

1. Field of the Invention

The present invention relates to a method, apparatus, system for image pre-processors. More particularly it relates to neural network implementations for image preprocessing. The present invention also relates to a neural network based element.

2. Background Information

Optical images typically contain large amounts of data. Processors examining the imaging data often have to sift through both relevant and irrelevant data, thereby increasing processing time. Pre-processing the data before reaching the processor and identifying regions of interest (ROIs) allows a processor to focus its resources on less data, reducing the amount of data that a processor must examine, and decreases processing time of the image. Pre-processing may include algorithmic treatment, for example using neural networks, or physical systems such as optical processing.

To aid in understanding of the principles of the present invention, some known neural network-based pre-processing and optical processing techniques are next described.

### I. NEURAL NETWORKS AND PULSE COUPLED NEURAL NETWORKS (PCNN)

### I1. Segmentation

A typical neural network is composed of a network of neurons, where a neuron is a component that is signally linked to other neurons and derives its output from input and linking signals. Such a neural network may be implemented by linking several neurons together. Algorithmically, computer scientists have incorporated neural networking by serially reading data and post-processing the data in a simulated neural network. The neural network in this case is not truly parallel and thus some of the benefit of using a neural network is lost.

In image processing, the image is projected onto a pixelated array. Each pixel essentially quantizes the image into a uniform image value across the pixel. The data values from the pixels are fed into a data storage unit where a processor can analyze the values serially. Typically, an image is being analyzed for a particular purpose (e.g., military targeting, medical imaging, etc.) and much of the pixel data is not useful for the intended purpose. The extra data increases the processing time of the image, in some cases making the image useless for decisions. For example, if the imaging time for a military aircraft is several seconds, the vehicle could significantly move before a targeting decision can be made.

A way of decreasing the data analyzed by the processor is to eliminate the useless data and provide only data of interest by segmenting the pixelated array of data into regions of interest. One technique for segmenting the pixelated data is to look at the data values of each pixel and set the values above a threshold level to “1” or some other numerical value and the rest to “0” or some other minimum value (called a thresholding method). Thresholding methods, however, yield undesirable results if a proper thresholding value is not chosen. If the value of the threshold is less than the optimum value, regions of no interest are selected along with the regions of interest. If the threshold value is greater than the optimum value, the true regions of interest may be deleted. An alternative method of segmentation is to use neural networks to pre-process data.

A PCNN is a laterally connected network of artificial cortical neurons known as pulse coupled neurons. PCNNs result in significantly better segmentation and smoothing results than most of the popular methods in use. A PCNN derives all needed parameter values automatically from the image without relying on the selection of proper thresholding values. Methods of using PCNN algorithms for image processing are discussed in Kuntimad G. 1995 (“Pulse coupled neural network for image processing,” Ph.D Dissertation, Computer Science Department, The University of Alabama in Huntsville, 1995).

FIG. 1 shows a flow diagram of the functional features of a typical pulse coupled neuron 10 which may be an element in a PCNN, which has three major functional parts: pulse generation 30; threshold signal generation 40; and a linking generation and reception 20. Each neuron 10 receives an external input X(n,m,t), which is also referred to herein as X(t), and decaying linking inputs from all neighboring neurons that have fired. The initial strength of the linking input from one neuron to another may be inversely proportional to the square of the distance between them. The linking generation and reception function 20 gathers linking inputs L(1,1) . . . L(i,j) from individual neurons to produce the net linking input Lₛᵤₘ(t) The internal activity of the neuron denoted by U(n,m,t), which is also referred to herein as U(t) is analogous to the membrane potential of a biological neuron. It is computed as the product of X(t) and (1+BLₛᵤₘ(t)), where B is a positive constant known as linking coefficient. In addition to receiving U(t), the thresholding function 40 receives a second input known as threshold signal (T(t)). The threshold signal may remain constant or decay depending on the application and mode of network operation. In contrast, the typical thresholding method compares a pixel's value to a threshold level with no inputs from neighboring pixels. In any case, when the value of the internal activity is greater than the value of the threshold signal (i.e., when U(t)>T(t)), the neuron fires (function 40). In other words, the thresholding function 40 sends a narrow pulse on Y(t), the neuron's output. As soon as the neuron fires, linking inputs are sent (function 50) to other neurons in the network and the threshold signal is charged and clamped to a high value. This disables the neuron from further firing unless it is reset. A firing neuron can cause other neurons to fire. This process in which pulsing neurons cause other neurons to pulse by sending linking inputs in a recursive manner is known as the capture phenomenon. The PCNN, because of the capture phenomenon, is capable of producing good segmentation results even when the input images are noisy and of poor contrast. If the internal activity is less than the threshold value (i.e., when U(t)<T(t)), then the cycle starts again and new linking inputs are entered (function 20).

A sample pixelated array 70 and PCNN function for such an array are shown in FIG. 2A with the simulated activity shown in FIGS. 2B-2E. A neuron N(i,j) is associated with a pixel (i,j). Each neuron is connected to each of its neighbors and sends linking input to them. The number of neurons, in this example, is equal to the pixels and there is a one-to-one correspondence. For example, for pixel (n,m) in a pixelated array 70, the internal equation 80 is composed of a linking coefficient B, a linking sum Lₛᵤₘ, and neighboring intensities Iᵢⱼ. A linking equation 90 calculates the final linking value based upon chosen linking coefficients (e.g., 0.0, 0.5, and 1.0) and respective intensities Iᵢⱼ. In this example, Lₛᵤₘ=0.5(I₁₁)+1.0(I₁₂)+0.5(I₁₃)+0.0(I₂₂)+1.0(I₂₃)+0.5(I₃₁)+1.0(I₃₂)+0.5(I₃₃)+values from further pixels. The internal activity U(n,m) is compared to a threshold level. If the threshold level is reached then the pixel (n,m) is assigned a particular value (typically 1), which is output Y(n,m). FIG. 2B shows a simulated image. The image is composed of a 5×5 image projected on a pixelated array. FIG. 2C shows the pixel values due to pixel input data with no linking values (L=0), where each value of the pixel equation X(1+BL)>T are assigned a value (e.g., 1) and where values below the threshold value are assigned a 0. FIG. 2D shows the pixel values including linking data (L≠0). FIG. 2E shows the PCNN processed image where the values of the pixels are assigned a value, 1 in this case, based on whether its internal activity value (X(1+BL)) is greater than or less than the threshold value. The image in FIG. 2E has no “grey” values, instead containing only values of 1 or 0 and could constitute a segmentation of the image into regions of 1-values and 0-values.

In order to segment an image into its component regions, PCNN parameters are adjusted such that neurons corresponding to pixels of a region pulse together and neurons corresponding to pixels of adjacent regions do not pulse together. Thus, each connected set of neurons pulsing together may identify an image region. This concept can be extended for images with multiple regions. When parameter values that guarantee a perfect segmentation result do not exist, an iterative segmentation approach has been used. In this approach, network parameters are updated based on the result of the previous iteration. The inclusion of an inhibition receptive field is found to improve the performance.

### I2. Smoothing

Another desirable pre-processing function that may be performed by the PCNN is the smoothing of digital imagery. When a digital image is applied as input to the PCNN and the network is enabled, threshold signals of all neurons decay from Tmax to a small value greater than zero. The time duration needed for the threshold signal to decay from Tmax to its minimum value is known as a pulsing cycle. During each pulsing cycle, as the threshold signal decays, neurons corresponding to pixels with an intensity greater than the threshold signal fire naturally. These neurons send linking inputs to their neighbors and may capture some of them. This process of fire-link-capture continues recursively. Each neuron is allowed to pulse exactly once during a pulsing cycle.

In a PCNN, the image is smoothed by adjusting pixel intensities based on the neighborhood-firing pattern. The neighborhood-firing pattern is the output pattern provided by pixels neighboring the pixel of interest. In general, a neuron N(i,j) corresponding to a noisy pixel does not fire with the majority of its neighbors. This means that neurons corresponding to noisy pixels, in general, neither capture neighboring neurons nor are captured by the neighboring neurons. Assume that a noisy image is applied as input to a weakly linked (e.g., low value linking coefficients) PCNN. The object is to smooth the values of the pixels by varying the input values X(i,j) to a neuron N(i,j) associated with the pixel until a majority of neighboring neurons fire, then keep the input value obtained to satisfy the majority firing condition and use it as the image pixel value. Finding the correct input value X(i,j) for neuron N(i,j) is performed recursively. When neuron N(i,j) pulses, some of its neighbors may pulse with it, some of its neighbors may have pulsed at an earlier time and others may pulse at a later time. If a majority of the neighbors have not yet pulsed, the intensity of the input value, X(i,j), is decreased by a value C from an average value, where C is a small positive integer and an average value is the value as if half of the neighbors have pulsed. If a majority of the neighbors of pixel (i,j) have pulsed at an earlier time, the intensity of X(i,j) is increased by C. If pixel (i,j) pulses with a majority of its neighbors then X(i,j) is left unchanged. At the end of the pulsing cycle, the PCNN is reset and the modified image is applied as input and the process is repeated until the termination condition is attained, no change in the input values X(i,j)s. Unlike window based image smoothing methods, the PCNN does not change the intensities of all pixels. Intensities of a relatively small number of pixels are modified selectively. Most pixels retain their original values. Simulation results show that PCNN blurs edges less than lowpass filtering methods. However, the method requires more computation than other smoothing algorithms due to its iterative nature.

### II. OPTICAL PROCESSING

One possible method of reducing the data reaching a processor that functions as an object detector is to run the image through an optical processor such as an optical correlator. Optical processing is the use of images, optical lenses, and/or filters to treat the image before detection by sensors. An example of optical processing is the interactions of light from an object so that there are phase and correlation differences between an initial image and a reference image. Light from an imaged scene can pass through a series of lenses and filters, which interact with the incident light, to create a resultant beam containing information on parts of the image that are of interest. For example a camouflaged manmade object in the jungle will have polarization effects on the image light different than those of the neighboring jungle. An optical processor filtering polarization effects may be able to identify the hidden object more quickly than using digital processors to treat the image.

Optical processors have advantages over digital processors in certain circumstances, including true parallel processing, reduced electrical and thermal power considerations, and faster operations in a smaller package.

There is a growing need for fast, accurate, and adaptable image processing for reconnaissance imagery, as well as the traditional desire for fire-and-forget missile guidance, which has spawned renewed interest in exploiting the high speed, parallel processing long promised by pre-processing. The real bottleneck still remains, however—data conversion. The data, in this case imagery, is usually in an electrical format that must be encoded onto a coherent laser beam, for optical pre-processing. Once the optical pre-processing is complete, the data must once again be converted into an electronic format for post-processing or transmission. While the optical processing takes place at the speed of light, the data conversion may be as slow as a few hertz to a few kilohertz. Limiting post-processing to ROIs can significantly aid in minimizing processing time. Pre-processing algorithms can also accomplish minimizing post-processing times.

Improved techniques for image pre-processing and/or methods of reducing data noise and emphasizing image regions of interest would greatly improve medical imaging and diagnostics. For example, researchers have studied the patterns of lung scan interpretation for six physicians over a four year period. The investigators found large variation in interpretation results obtained from these physicians. The study of lung scan interpretations has shown that radiologists disagree on the diagnosis in one-third of the cases, with significant disagreements in 20% of the cases. In fact, disagreements as to whether the case is normal or abnormal occur in 13% of the cases. Other investigators have shown that radiologists disagree on the location of pulmonary defects in 11-79% of the scans. This renders initial screening difficult. The location of the pulmonary defect affects the treatment plan. New image processing technology can improve the diagnostic outcome for patients and can be used in many medical imaging systems such as mammography, X-ray, computed tomography (CT), magnetic resonance imaging (MRI) and other digitally acquired data sets.

### SUMMARY OF THE INVENTION

It is therefore an object of the present invention to provide an optical image device and method that reduces the data to be processed by image processors and increases the efficiency due to the reduced data flow. It is further an object of the present invention to provide a method and device that uses a neural network to pre-process the data received by the sensors before extensive processing. It is also an object of the invention to provide a neural network element that is suitable for pre-processing image sensor data.

These and other objects of the present invention may be realized by providing a device using a neural network, such as a PCNN, as the analysis tool for segmenting and smoothing image data received by the sensors and incorporating sensing and processing circuits, for example a PCNN processing circuit, together in a camera pixel. The PCNN isolates regions of interest with sufficient accuracy to permit the detection and accurate measurement of regional features. These and other objects are also realized by providing integrated imaging and neuron circuitry.

According to one implementation of the present invention, the sensor connected to the processing circuit may contain an optical element, for example a microlens. By integrating optical processing, digital sensing, and neuron pre-processing on an individual pixel level, parallel pre-processing of sensor data, for example image data, is facilitated. The present invention may be implemented by combining optical processors with a pixel containing a sensor element and a neuron circuit.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings, which are given by way of illustration only, and thus are not limitative of the present invention, and wherein:

FIG. 1 is a flow diagram illustrating the functional features of a pulse coupled neuron;

FIG. 2A is a diagram illustrating an exemplary pixelated array and linking relationship between neurons;

FIGS. 2B-2E is a diagram illustrating a simulation of an image processed by a simulated PCNN circuit;

FIG. 3 is a diagram illustrating an exemplary layout of a camera pixel made in accordance with the present invention wherein a sensing and processing circuit have been combined into a pixel;

FIG. 4 is a block illustration of the pixel of FIG. 3 with elements of the PCNN circuit described in more detail;

FIGS. 5A-5I are illustrations of various pixel designs conforming to the present invention;

FIG. 6 shows the use of an optical element in combination with a pixel as shown in FIGS. 5A-5I;

FIG. 7 shows the linkage of various instruments comprised of camera pixels according to embodiments of the present invention;

FIG. 8 illustrates the neural network of the arrangement of devices shown in FIG. 7, whereby a super neural net is formed;

FIG. 9 shows the locations of typical defects that occur in the lungs;

FIG. 10 illustrates a series of lung scans using a simulated version of the of a device constructed in accordance with an embodiment of the present invention; and

FIG. 11 illustrates a series of images representing image processing of a target or surveillance image using a simulated version of a device constructed in accordance with an embodiment of the present invention.

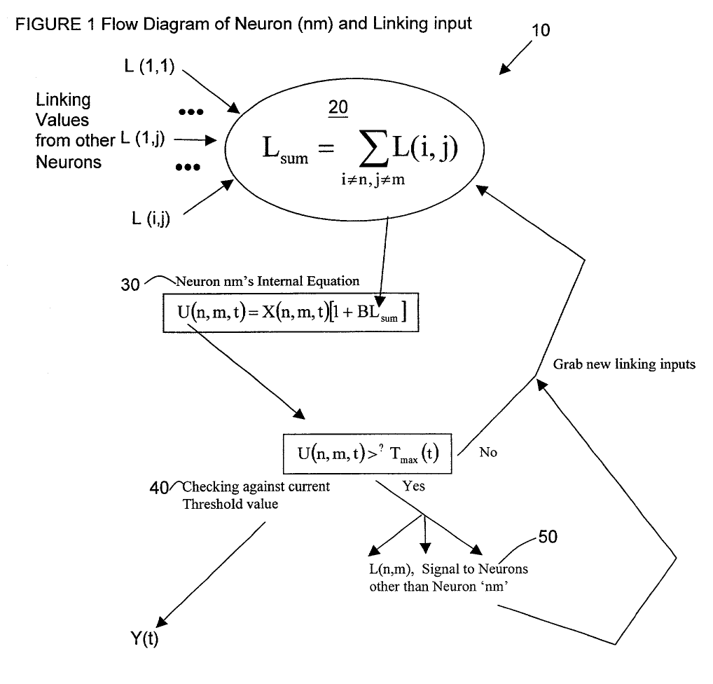

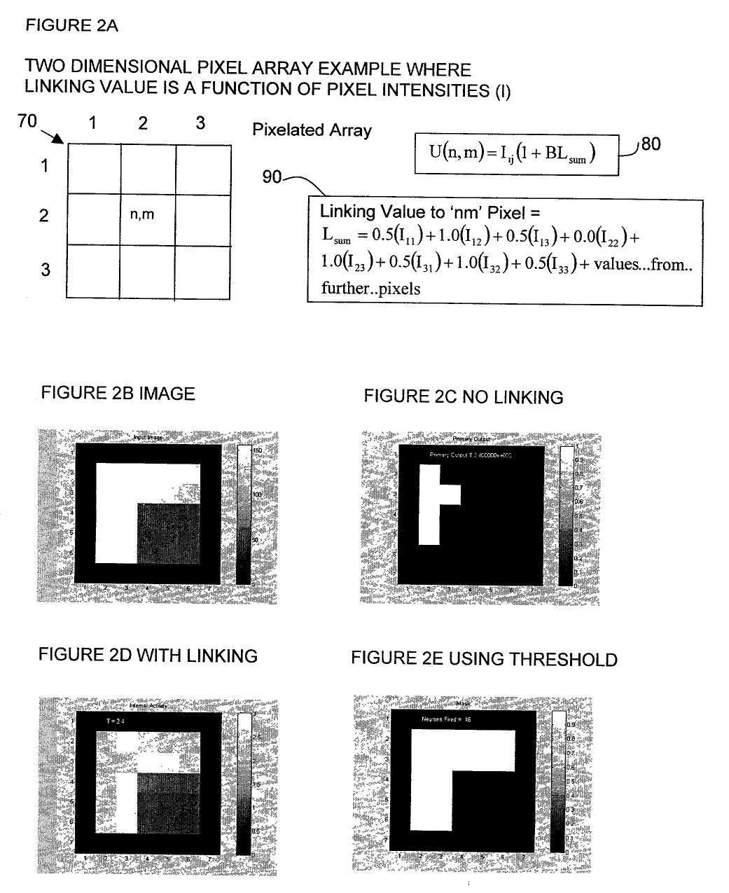

### DETAILED DESCRIPTION

The present invention is an integrated circuit containing a neuron circuit that can be used for pre-processing sensor data provided by a sensor element integrated on the same integrated circuit as the neuron circuit or connected to the neuron circuit by a signal conduit.

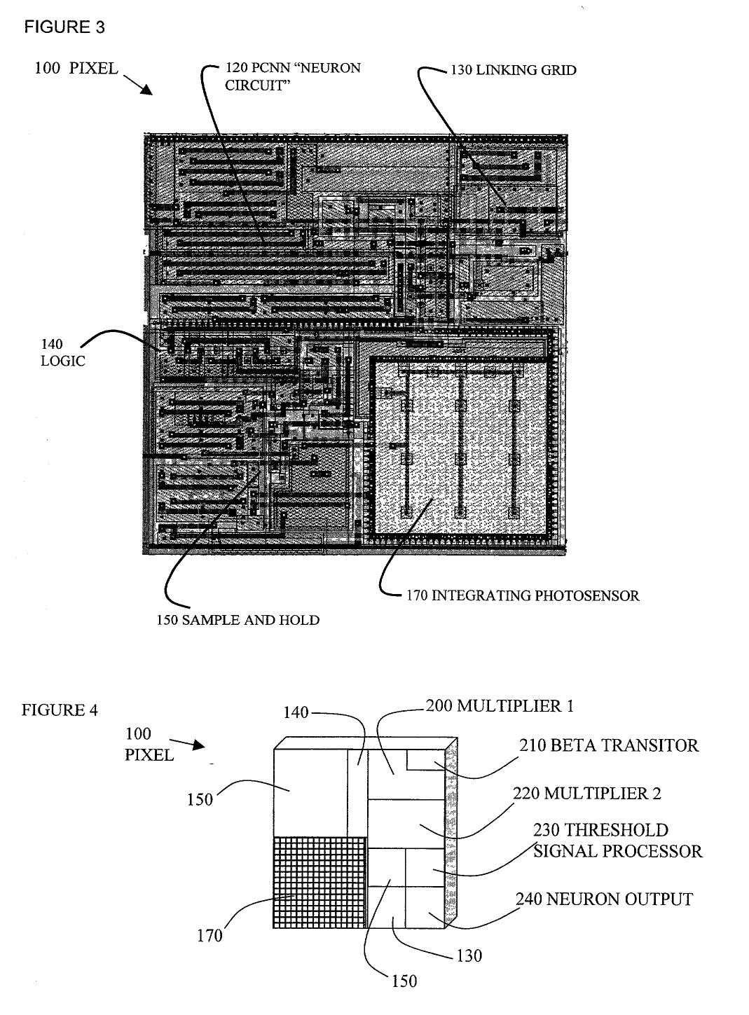

In accordance with various exemplary embodiments of the present invention, a PCNN, is implemented as a smart focal plane of an imaging device. Each laterally connected neuron is embedded in a light sensitive pixel that communicates with other neurons through a network of resistance. Using an array of such neurons, the camera may segment the background portions of an image and remove background portions from the image. Areas of pixels with similar intensity may bind and pulse together as a single unit, efficiently segmenting the image even in the presence of substantial noise. The remaining pixels are among the ROIs and available for further evaluation. FIG. 3 illustrates an exemplary pixel 100 developed in accordance with the present invention. The pixel 100 contains a photosensor 170, a sample and hold circuit 150, a neuron circuit 120, for example a pulse coupled neuron circuit, a linking grid 130, and a logic circuit 140. The algorithm implemented by the pixel may be represented as: U(Comparator Output)=X(input)*AmpGain*(1+Beta*Lₛᵤₘ*Nbias), where the comparator output is the value compared against a threshold value, X(input) is the value corresponding to a read pixel photon input (pixel input signal), AmpGain determines the relative gain of the pixel input signal X(input), and Beta (also referred to herein as “B”) is a constant chosen by the operator which determines the strength of the linking field, “Lₛᵤₘ” (also referred to herein as “L”). Nbias determines the current output of the analog output of the pixel and thus controls the decay of the linking field on the resistive grid. Other neuron analog circuits can be used and the discussion herein should not be interpreted to limit the present invention to PCNN circuits. The sensor of the present invention may be a sensor other than a photosensor and the discussion herein should not be interpreted to limit the present invention to a type of sensor.

The PCNN circuit 120 may compute X*(1+Beta*LₛᵤₘNbias) or X*(1+B*LNbias) with an analog current computational output. The circuit may include a mode control circuit, allowing switching between inverting and noninverting (0 high or 0 low camera) modes. The computational output is compared to a threshold signal and set high or low depending upon the mode selected. Other modes can be used and the discussion herein should not be interpreted to limit the number of modes of the present invention.

All of the pixel analog outputs are connected to a resistive (resistor or transistor) grid, the linking grid 130, which includes connections going to each adjacent pixel analog input. If a particular output from another pixel is active (voltage or current above a certain level) the signal is pulled form the other pixel and added to the calculation of the linking field value. The logic circuit 140 controls the firing of the output of a neuron, disabling the neuron after firing once until a pulse cycle is complete. As used herein a pulse cycle refers to a chosen period of time to define the shortest neuron output activity.

The sample and hold circuit 150 is an active element used to collect an input signal and store it for both PCNN processing and data export off the focal plane array, where the focal plane array is defined as the region defined by the pixels arranged to communicate amongst each other.

FIG. 4 illustrates a block version of the circuit shown in FIG. 3. The PCNN circuit 120 is further defined by a multiplier 200, which computes the Beta and Linking field values (BL). The Beta value is obtained by the Beta Transistor 210 where “B” is the linking field strength, whose value (voltage) is obtained by varying the Beta transistor input voltage. A second multiplier 220 computes the input value “X” and the quantity (1+BL). A threshold signal processor 230 inputs the computational output from the neuron and a global (to the pixel) threshold level. The threshold signal processor 230 compares the two inputs and determines and sets the state of the neuron. The global threshold level can be spatial and temporally variant. For example, each pixel can have different threshold values (spatially variant), or the threshold values can change with time (temporally variant). The state set by the threshold signal processor 230 is output through the neuron output 240. Typically for segmentation and regional identification the neuron output is 0 or 1 but other values can be used and the discussion herein should not be interpreted to limit the output values of the neuron state. Values used for computation are stored in the sample and hold region 150 of the pixel 100.

The advantage of this embodiment of the present invention over computational neural networks is the incorporation of the analog neuron circuit on a chip that incorporates signals from a sensing element that may also be on the same chip, allowing pre-processing in a semi-parallel manner (serial processing of data on a single chip and parallel processing between chips) before the data reaches a processor.

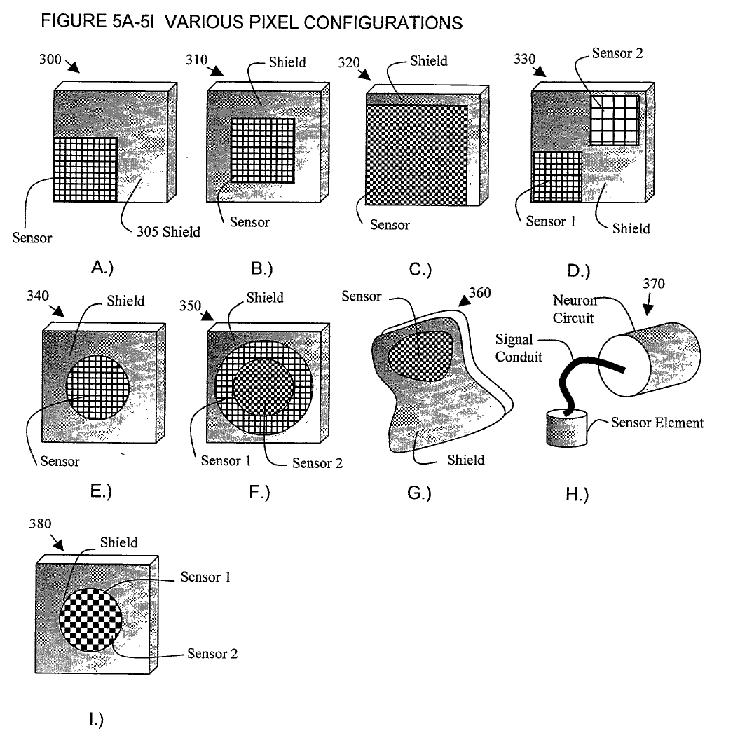

Embodiments of the present invention include various pixel configurations and sensor-neuron processor combinations. FIGS. 5A-5I illustrate various configurations made in accordance with the present invention. To minimize pixel to pixel gain and offset variations when the pixels are arranged in a pixelated array a metal shield 305 is used to cover the non-sensor areas. Referring to FIG. 5A, pixel 300 is a pixel in accordance with the present invention as described above, however the sensor element may be moved to various locations on the pixel as shown in FIG. 5B, pixel 310. The coverage area of the sensor may be increased as shown in FIG. 5C, pixel 320, or the shape of the sensor element varied as shown in FIGS. 5E and 5G, pixels 340 and 360, respectively. The present invention encompasses at least one sensor element but may include more on the same chip as shown in FIGS. 5D, 5F, and 5I, pixels 330, 350 and 380, respectively. Pixels 330 and 350 contain two sensor elements regionally separated, wherein pixel 380 contains two sensors combined. Further in accordance with the present invention the sensor element may be removed from the neuron circuit and connected to a neuron circuit by a signal conduit as shown in FIG. 5H, pixel 370. Other various shapes of pixels made in accordance of the present invention are possible and the discussion herein should not be interpreted to limit the pixels to a planar shape.

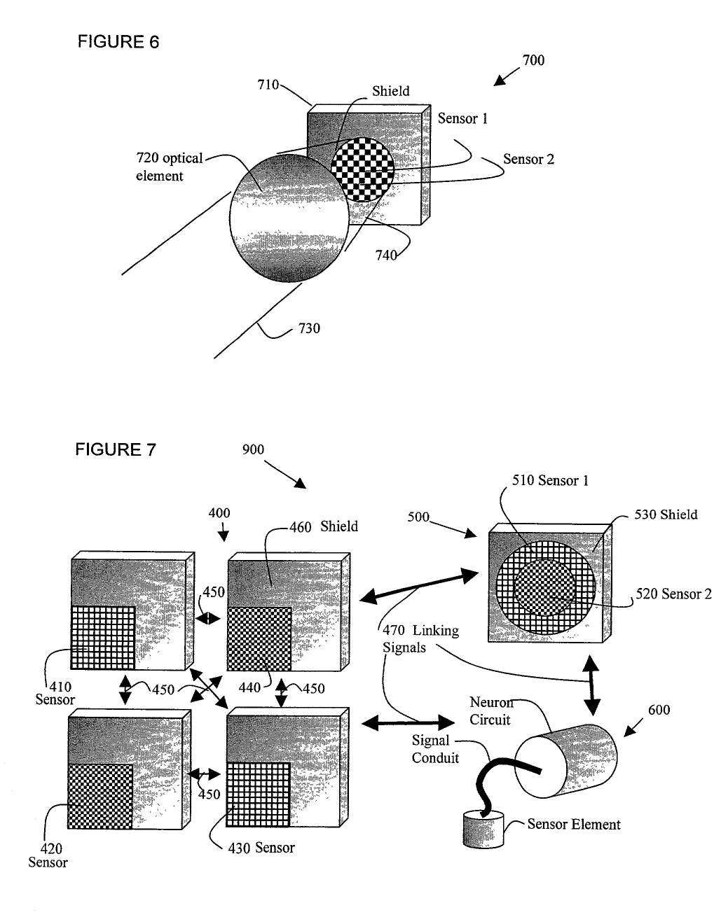

In addition to increasing the size of the sensor to increase the coverage area, an optical element may be used to focus the light onto the sensor area. The optical element may also be an optical processor. FIG. 6 illustrates a pixel 700 according to an embodiment of the present invention. The pixel 700 includes a chip pixel 710 made in accordance with the present invention as discussed above, incorporated with an optical element 720. An incident image defined by the rays 730 is focused by the optical element 720, resulting in a focused beam 740 onto the sensor plane of the chip pixel 710. In the illustration shown in FIG. 6, the chip pixel 710 is composed of two integrated sensors, sensor 1 and sensor 2. In the embodiment shown in FIG. 6, the combination of the optical element 720 and the chip pixel 710 would be simply referred to as a pixel. Without the optical element, the chip pixel would be referred to as a pixel. The optical element may be an optical correlator or other imaging treatment system allowing the treated image to pass to the pixelated array, which may or may not increase the physical coverage of the sensor and the discussion herein should not be interpreted to limit the optical elements to only those elements increasing the coverage. It is intended that the scope of the invention (and FIG. 6) includes a configuration in which optical pre-processing is combined with a pixel constructed in accordance with the embodiment of the present invention discussed above.

In addition to individual pixels, separate instruments can serve as neurons in a neural network of the present invention used in combination with pixels constructed in accordance with the present invention, creating multiple pixel and instrument neurons whose combination results in an overall system within the intended scope of the present invention. FIG. 7 illustrates an exemplary combination of a pixelated array 400, a two-sensor pixel 500, and a detached sensor pixel 600 into a composite system 900 (“super pixelated array”) according to an embodiment of the present invention. A pixelated array is a combination of pixels that directly link with each other through linking signals. The super pixelated array 900 has an associated super neural network. The two-sensor pixel 500 is composed of two regionally separated sensors 510 and 520 with the non-sensor regions covered by a metallic shield 530. The pixels arranged in the pixelated array 400 are comprised of various pixels with various sensors 410, 420, 430, and 440. The pixels in the pixelated array 400 communicate with each other directly through linking signals 450. The pixelated array output 470 can be used as a linking signal connecting independent pixels 500 and 600. As stated above, various combinations of pixelated arrays and super pixelated arrays are possible and the discussion herein should not be interpreted to limit the arrangement of pixels or their interaction.

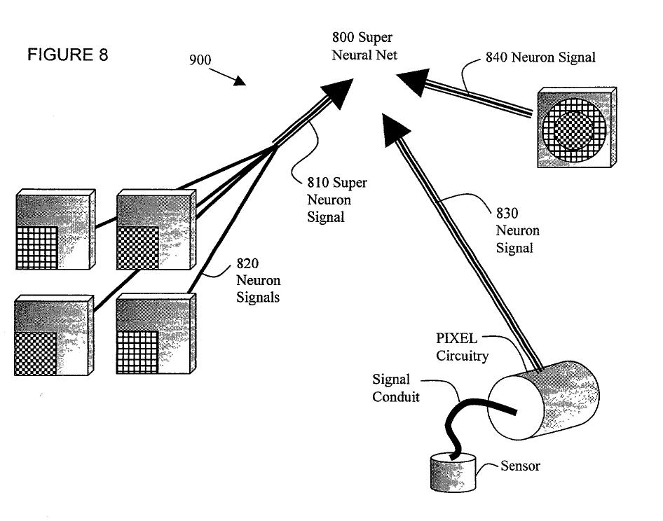

Super pixelated arrays result in neuron signals that can be combined so that pixelated arrays contained in the super pixelated array output a single output. FIG. 8 illustrates an embodiment of the present invention implementing the super pixelated array 900 shown in FIG. 7 (linking lines 450 and 470 not being shown for simplicity). The linking neuron signals 820 between the pixels of a pixelated array connect the pixels of the array. The combined linking signals can constitute a separate pixelated array signal 810 that feeds into a super neural network 800. Other inputs 830 and 840 from separated pixels constitute the remaining signals in the super neural network 800. Such a system is useful when processing can be limited to conditions when each neuron shows certain predetermined values. For example, the pixelated array may be a combination sensor system containing infrared and polarization detection sensors. The detached sensor pixel resulting in neuron signal 830 may be a motion sensor and the dual sensor pixel 840 may be another infrared/polarizer pixel. Each pixel or pixelated array may send a signal indicating detection. For example, the pixelated array may detect a manmade object by the contrast between the polarization detected and the infrared detected and send a super neuron signal 810 of value 1 to the super neural network 800. The motion sensor 830 may detect motion toward the super pixelated array 900 and the dual sensor pixel 840 may detect the characteristics of the moving object. If all neuron and super neuron signals are positive (or in this case 1), then the signal is sent to a processor to analyze. A linking equation similar to that described above may be used to link the neurons and super neurons (for example the pixelated array 400 would be a super neuron) for pre-processing of sensor data. Many variations of sensing devices including imaging devices can be used and linked in a manner consistent with the present invention and these variations are intended to be within the scope of the present invention.

A pixelated array as described above, for example 400 in FIG. 8, may be used as a focal image plane for a camera. The pixelated array is configured to implement a ROI locator as a real-time sensor integrated with a processor. The result is a camera that evaluates data as it sees it. Each frame imaged has associated with it processes which are followed for frame processing using the pixelated array. The process steps taken at every threshold level, in accordance with a process of the present invention, include deactivating the neuron, adjusting the threshold level, and reading the ROI data. The user can set the number of thresholds to process per frame. At each threshold level the pixels associated with the ROIs are read out of the pixelated array and passed with the original digitized image to an on-camera-board processing module. A camera using a pixelated array constructed according to embodiments of the invention can process many ROI thresholds. If an application requires fewer ROI thresholds, a higher frame rate can be obtained. Alternatively, the configuration allows one to operate the ROI camera with more thresholds, for more detailed processing, at lower imager read-out speeds. Other cameras can process more frames per second and utilizing such cameras to improve the ROI threshold processing rate, using the method of the present invention is intended to be included in the scope of the present invention.

Photo-sensors are used in the pixels described above in embodiments of the present invention. The photo-sensors are able to meet a variety of light input ranges and conditions that include daylight, laser light, and night or astronomical applications. In a prototype using the method and device of the present invention, a high efficiency photosensor operating at 800 nm-wavelength light is used. Other photosensors may be coupled to the network neurons and the discussion herein should not be interpreted to limit the type or operating range of the photosensors used.

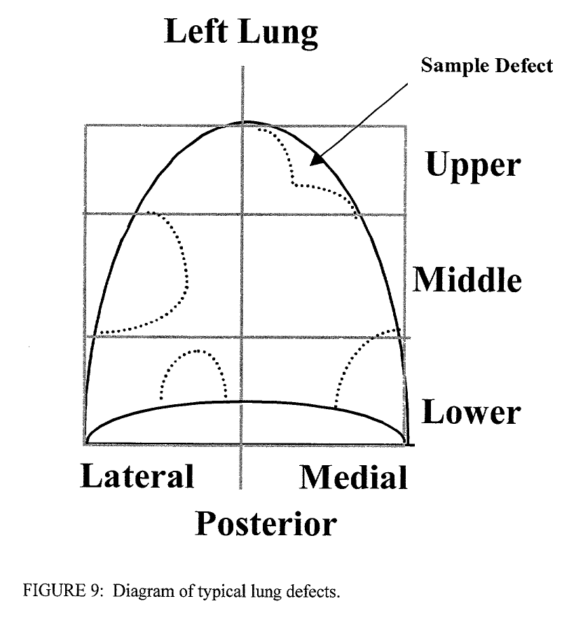

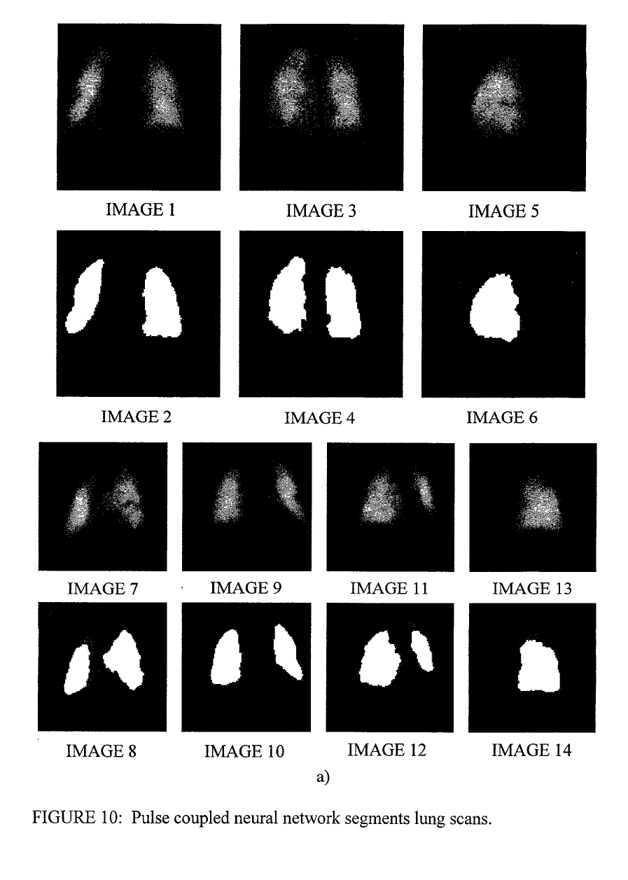

A simulation of the performance of a camera device using a pixelated array constructed and processed in accordance with an embodiment of the present invention is shown in FIG. 10. The simulation utilized imaged data from a gamma ray detector for lung imaging. The values of the pixels were used as inputs to a simulated neuron circuit, as according to the present invention. The inputs were entered into the simulated neurons, with each neuron associated with a pixel. The simulated neurons were linked by a linking equation, as discussed above. The result was a simulated device having the same characteristics as a device constructed using pixels according to embodiments of the present invention as discussed above. The simulated device was developed into a physician's tool for the detection of pulmonary embolism. The “fuzzy” images, shown as the odd images, correspond to the detector images and the solid white images, shown as the even images, corresponding to the simulated device neural net output images. The simulated device identifies the group of pixels that form the left and right lungs, allowing the detection of shape comparison between a healthy lung and the detected lung as illustrated in FIG. 9. Shape comparison can be used for product quality detection on a production line or a pre-processor counting system. The simulated device reliably locates the lung boundary and is very tolerant of noise and other image quality detractors. The number of defects, their size and their location with respect to other defects are all diagnostic indicators. The diagnosis algorithm, which uses the original as well as segmented binary images of lungs as inputs, performs very well.

The immediate advantage of the simulated device is the speed of providing useful images for analysis. The simulated device, whose images are shown in FIG. 10, additionally helped minimize interpretation variability of images. For example, among trained experts, a study revealed as much as 30% interobserver variability for classifying intermediate or low probability of having pulmonary embolism. Currently 20-70% of patients are classified as intermediate. The simulated device according to the present invention classified only 7% as intermediate. Greater than 80% of radiographic findings are in the high category for pulmonary embolism. The computer correctly classified 100% of these cases. Some 0-19% of patients are classified as low, of these the computer correctly classifies 94%. The distribution and use of a device according to the present invention would have eliminated 22% of this study's patient population from undergoing unnecessary follow-up therapy. The impact of the simulated device is improved patient care at lower costs.

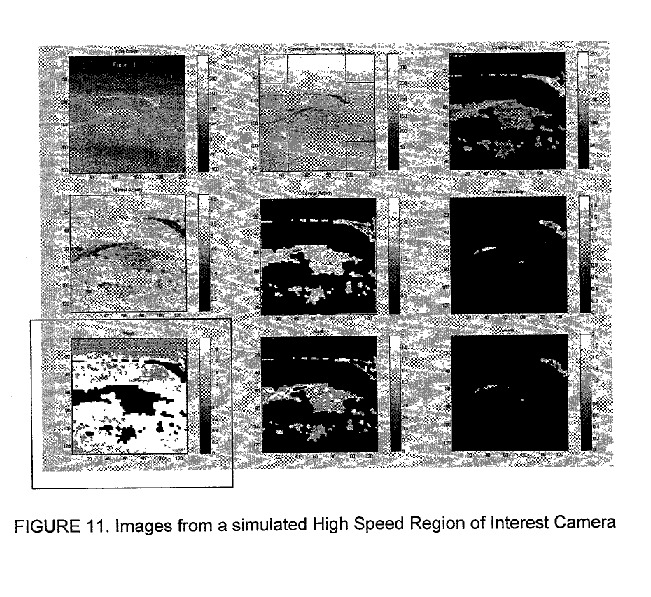

A simulation of the performance of a camera device using a pixelated array constructed and processed in accordance with an embodiment of the present invention is shown in FIG. 11. FIG. 11 shows 9 images displaying the treatment of an initial image (top left). For example the image can be for a surveillance or military tracking system. The image is first inverted, the high pixel value is now 0, as shown in the top middle image. The black lines on the image (center top row) are artifacts placed over the image to illustrate that the following images are expanded views of the center of this image. The simulated pixelated array defining an image focal plane sees an image shown in the top right image. The image pixel values vary from 0 to 255 and is not inverted. The middle row of images shows steps in the PCNN process simulating an analog PCNN circuit combined to a sensor element. Each image shows an internal picture with a lower threshold, the threshold drops with each image as read from right to left. The top right image has the highest threshold and the lower right image has the lowest threshold. The images are processed in the inverted mode so the brightest pixel in the original image is associated with the last threshold level. The images processed are the interior of the top middle image. In the entire middle row the white pixels are those that have a value over the current threshold. The grey pixels are those that fire due to the effect of the linking. The last row continues the process shown in the middle row. The threshold drops and pixels fire. The lower left image is identified as significant because the background is segmented in one large and complete group. The region of interest containing the tanks is identified by the white pixels in the last, lower right frame.

A similar device incorporating pixelated arrays in accordance with the present invention can be used for a product tracking system where regions of interest can be compared to stored shapes and images and used to count products with little post-processing. Such a device can be placed on product lines to count and detect simply defects.

Many variations in the design of incorporating a PCNN circuit or other neural circuit with a sensor on a chip or connected in a pre-processing configuration may be realized in accordance with the present invention. It will be obvious to one of ordinary skill in the arts to vary the invention thus described. Such variations are not to be regarded as departures from the spirit and scope of the invention, and all such modifications as would be obvious to one skilled in the art are intended to be included within the scope of the following claims.

We claim:

1. An integrated neuron circuit comprising:
a linking circuit, receiving and sending a linking signal from/to another neuron circuit;
an input circuit, receiving an input signal;
an output circuit, sending an output signal to a processor; and
a processing circuit, generating said output signal based on said input signal and said linking signal.

2. An integrated pixel circuit comprising:
a neuron circuit containing:
a linking circuit, receiving and sending a linking signal from/to another neuron circuit;
an input circuit, receiving an input signal;
an output circuit, sending an output signal to a processor; and
a processing circuit, generating said output signal based on said input signal and said linking signal; and
a sensor element, wherein said sensor element provides said input signal and said sensor element and said neuron circuit are integrated on the same chip.

3. A pixelated array comprising:
a plurality of neuron circuits, wherein a neuron circuit contains:
a linking circuit, receiving and sending a linking signal from/to another neuron circuit, where the connected neurons constitute an array;
an input circuit, receiving an input signal;
an output circuit, sending an output signal to a processor; and
a processing circuit, generating said output signal based on said input signal and said linking signal; and
a plurality of sensor elements, wherein each sensor element provides said input signal to an associated neuron circuit in said array and said sensor element and said neuron circuit are integrated on the same chip, said chip is associated with an pixel, and a plurality of pixels constitutes a pixelated array.

4. A neuron array comprising:
a plurality of neuron circuits, wherein a neuron circuit contains:
a linking circuit, receiving and sending a linking signal from/to another neuron circuit, where the connected neurons constitute an array;
an input circuit, receiving an input signal;
an output circuit, sending an output signal to a processor;
a processing circuit, generating said output signal based on said input signal and said linking signal; and
a plurality of sensor elements, wherein each sensor element provides said input signal to an associated neuron circuit in said array, said associated neurons in said array constituting a neuron array.

5. A method for processing an image frame in a neural network comprising:
establishing a correspondence between a plurality of pixels representing an image frame and a plurality of neural elements, wherein a neural element communicates to other neural elements, and each neural element is composed of an integrated circuit containing a sensor element and a neuron circuit, where said sensor element provides input to said neuron circuit;
capturing information associated with said image frame in the neural network by recursively linking the plurality of said neural elements to each other using a linking criteria; and
segmenting the captured information into one or more regions by adjusting the linking criteria so that a subset of neural elements corresponding to said one or more regions are linked with each other and not with secondary neurons outside said one or more regions.

6. The method according to claim 5, wherein said neuron circuit is a pulse coupled neuron circuit.

7. The method according to claim 5, wherein said image frame includes a scene and the one or more regions correspond to one or more targets in the scene.

8. The method according to claim 5, wherein said image frame includes a medical diagnostic image and wherein the one or more regions correspond to one or more diagnostic features in the medical diagnostic image.

9. An apparatus for processing an image frame in a neural network comprising:
a plurality of pixels associated with an image frame; and
a processor receiving information from said plurality of pixels, said processor configured to;
establish a connection between said pixels and a plurality of neural elements, wherein each said neural element is composed of an integrated circuit containing a sensor element and a neuron circuit, where said sensor element provides input to said neuron circuit;
capture information associated with said image frame in the neural network, where said neural network is composed of said neural elements, by recursively linking said plurality of neural elements to each other using a linking criteria; and
segment said capture information into one or more regions by adjusting the linking criteria so that a subset of neural elements corresponding to said one or more regions are linked with each other and not with secondary neurons outside said one or more regions.

10. The apparatus according to claim 9, wherein said neuron circuit is a pulse coupled neuron neuron circuit.

11. The apparatus according to claim 9, wherein said image frame includes a scene and the one or more regions correspond to one or more targets in the scene.

12. The apparatus according to claim 9, wherein said image frame includes a medical diagnostic image and wherein the one or more regions correspond to one or more diagnostic features in the medical diagnostic image.

13. An integrated circuit for processing an image frame in a neural network, the integrated circuit comprising:
a plurality of neural elements, wherein each said neural element is composed of an integrated circuit containing a sensor element and a neuron circuit, where said sensor element provides input to said neuron circuit; and
a processor coupled to the plurality of neural elements, the processor configured to;
establish a correspondence between said plurality of pixels and a plurality of neural elements, wherein a neural element connects to neighboring neural elements;
capture information associated with said image frame in the neural network by recursively linking said plurality of neural elements to each other using a linking criteria; and
segment said capture information into one or more regions by adjusting the linking criteria so that a subset of neural elements corresponding to said one or more regions are linked with each other and not with secondary neurons outside said one or more regions.

14. The integrated circuit according to claim 13, wherein said neuron circuit is a pulse coupled neuron circuit.

15. The integrated circuit according to claim 13, wherein said image frame includes a scene and the one or more regions correspond to one or more targets in the scene.

16. The integrated circuit according to claim 13, wherein said image frame includes a medical diagnostic image and wherein the one or more regions correspond to one or more diagnostic features in the medical diagnostic image.

17. A system for processing an image frame in a neural network, the system comprising:
a frame capture device for capturing an image frame and generating a plurality of pixels corresponding thereto;
a processor coupled to said frame capture device, the processor configured to;
establish a correspondence between said plurality of pixels and a plurality of neural elements, wherein each said neural element is composed of an integrated circuit containing a sensor element and a neuron circuit, where said sensor element provides input to said neuron circuit, where a neural element connects to other neural elements;
capture information associated with said image frame in the neural network by recursively linking said plurality of neural elements to each other using a linking criteria; and
segment said capture information into one or more regions by adjusting the linking criteria so that a subset of neural elements corresponding to said one or more regions are linked with each other and not with secondary neurons outside said one or more regions.

18. The system according to claim 17, wherein said neuron circuit is a pulse coupled neuron circuit.

19. The system according to claim 17, wherein said image frame includes a scene and the one or more regions correspond to one or more targets in the scene.

20. The system according to claim 17, wherein said image frame includes a medical diagnostic image and wherein the one or more regions correspond to one or more diagnostic features in the medical diagnostic image.

21. A method for processing an image frame in a neural network comprising:
providing an optical processor, wherein said optical processor is placed between an image source and an image frame, said optical processor processing image data from said image source and projecting the processed data onto said image frame;
establishing a correspondence between a plurality of pixels representing an image frame and a plurality of neural elements, wherein a neural element communicates to other neural elements, and each neural element is composed of an integrated circuit containing a sensor element and a neuron circuit, where said sensor element provides input to said neuron circuit;
capturing information associated with said image frame in the neural network by recursively linking the plurality of said neural elements to each other using a linking criteria; and
segmenting the captured information into one or more regions by adjusting the linking criteria so that a subset of neural elements corresponding to said one or more regions are linked with each other and not with secondary neurons outside said one or more regions.

22. A method according to claim 21, wherein said optical processor is at least one optical correlator.

23. An apparatus for processing an image frame in a neural network comprising:
an optical processor, wherein said optical processor is placed between an image source and an image frame, said optical processor processes the image data from said image source and projects the processed data onto said image frame;
a plurality of pixels associated with an image frame; and
a processor receiving information from said plurality of pixels, said processor configured to;
establish a connection between said pixels and a plurality of neural elements, wherein each said neural element is composed of an integrated circuit containing a sensor element and a neuron circuit, where said sensor element provides input to said neuron circuit;
capture information associated with said image frame in the neural network, where said neural network is composed of said neural elements, by recursively linking said plurality of neural elements to each other using a linking criteria; and
segment said capture information into one or more regions by adjusting the linking criteria so that a subset of neural elements corresponding to said one or more regions are linked with each other and not with secondary neurons outside said one or more regions.

24. An apparatus according to claim 23, wherein said optical processor is at least one optical correlator.

25. A system for processing an image frame in a neural network, the system comprising:
an optical processor, wherein said optical processor is placed between an image source and an image frame, said optical processor processes the image data from said image source and projects the processed data onto said image frame;
a frame capture device for capturing an image frame and generating a plurality of pixels corresponding thereto;
a processor coupled to said frame capture device, the processor configured to;
establish a correspondence between said plurality of pixels and a plurality of neural elements, wherein each said neural element is composed of an integrated circuit containing a sensor element and a neuron circuit, where said sensor element provides input to said neuron circuit, where a neural element connects to other neural elements;
capture information associated with said image frame in the neural network by recursively linking said plurality of neural elements to each other using a linking criteria; and
segment said capture information into one or more regions by adjusting the linking criteria so that a subset of neural elements corresponding to said one or more regions are linked with each other and not with secondary neurons outside said one or more regions.

26. The system according to claim 25, wherein said optical processor is an optical correlator.
